(19) United States
(12) Patent Application Publication
(10) Pub. No.: US 2011/0077998 A1
(43) Pub. Date: Mar. 31, 2011

(54) CATEGORIZING ONLINE USER BEHAVIOR DATA

(75) Inventors: Jun Yan, Beijing (CN); Ning Liu, Beijing (CN); Lei Ji, Beijing (CN); Dong Zhuang, Beijing (CN); Zheng Chen, Beijing (CN)

(73) Assignee: Microsoft Corporation, Redmond, WA (US)

(21) Appl. No.: 12/568,707

(22) Filed: Sep. 29, 2009

(51) Int. Cl. G06Q 10/00; G06Q 30/00; G06F 17/30

(52) U.S. Cl. 705/10; 707/E17.017; 707/E17.044

(57) ABSTRACT

A method for categorizing online user behavior data, including creating a target set of users based on an advertiser query, identifying two or more users in the target set having one or more first similar behavior attributes using a Minhash algorithm; and modifying the target set according to the two or more identified users.

### BACKGROUND

Behavioral targeting is a technique used by online publishers and advertisers to deliver their most relevant advertisements to an audience that would be most interested in the advertisements. By examining an individual's web-browsing behavior, behavioral targeting techniques can hypothesize what products, services or other commercial activity in which each individual web user may be interested. Accordingly, behavioral targeting is an effective tool that helps advertisers to use their online advertisements more efficiently.

Traditional behavioral targeting techniques form groups of users based on predefined online behavior attributes. These predefined online behavior attributes may define how users may be grouped together. Typically, the users may be grouped together based on similarities between the user's online behavior attributes and the predefined online behavior attributes. Using predefined online behavior attributes to group users together, however, may group users too broadly or too narrowly. As such, the groups of users may not accurately identify the users who may be interested in an advertiser's advertisement. In some circumstances, none of the predefined behavior attributes may be relevant to an advertiser because they do not include any online behavior attributes that may be used to identify the users who may be interested in the advertisers' advertisements.

### SUMMARY

Described herein are implementations of various technologies for categorizing online user behavior data. In one implementation, a computer application may receive user behavior data and an advertiser query to categorize online user behavior data. The user behavior data includes information pertaining to one or more users and their corresponding online behavior attributes. The advertiser query includes one or more online behavior attributes that are of interest to an advertiser. The advertiser query may be used to identify a group of users which may be most interested in the advertisements of an advertiser. In one implementation, the online behavior attributes of the advertiser query may be defined by an advertiser in order to customize the categorization of online user behavior.

The computer application may use the user behavior data and the advertiser query to first identify a group of users that may have similar online behavior attributes as defined in the advertiser query. In one implementation, the identified group of users may be referred to as a user segment or a target set of users.

The computer application may then identify similarities between two or more users in the user behavior data based on a Minhash algorithm. The Minhash algorithm may calculate a Minhash signature for each user in the user behavior data. The computer application may then group users in the user segment based on similarities between the Minhash signatures of two or more users in the user segment. The groups of users in the user segment may be referred to as expanded user segments. The expanded user segments may identify similarities between two or more users of the users in the user segment who already share some similarities with each other. In this manner, the users grouped in the expanded user segments may be more closely related or may share a higher degree of similarity between the users. These groups with higher degrees of similarities may be useful to advertisers trying to market a product to a specific group of people. After determining the expanded user segments, the computer application may then display the expanded user segments to the advertiser. If the advertiser is unsatisfied with the expanded user segments, the computer application may receive a refined or new advertiser query from the advertiser. Upon receiving the refined or new advertiser query, the computer application may repeat the above process until the advertiser is satisfied with the expanded user segments.

The above referenced summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 illustrates a schematic diagram of a computing system in which the various techniques described herein may be incorporated and practiced.

FIG. 2 illustrates a data flow diagram of a method for categorizing online user behavior data in accordance with one or more implementations of various techniques described herein.

FIG. 3 illustrates an example of a method for expanding a user segment in accordance with one or more implementations of various techniques described herein.

### DETAILED DESCRIPTION

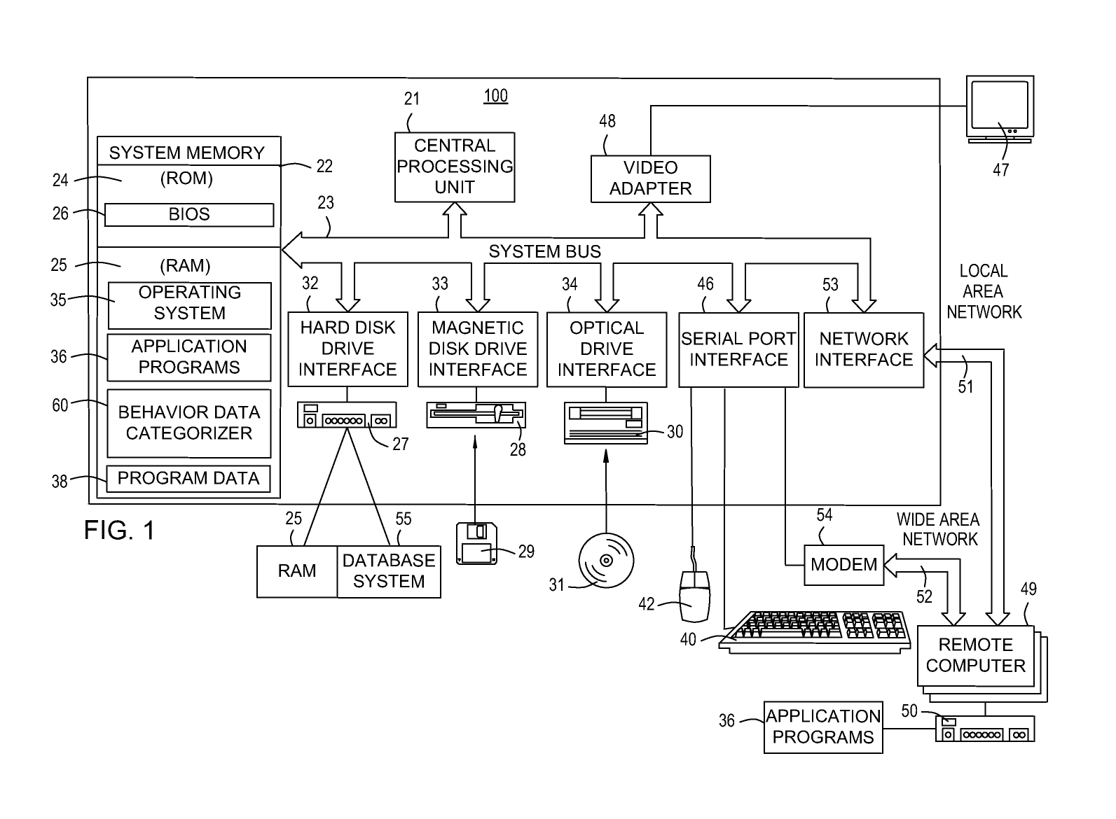

In general, one or more implementations described herein are directed to categorizing online user behavior data. Various techniques for categorizing online user behavior data will be described in more detail with reference to FIGS. 1-3.

Implementations of various technologies described herein may be operational with numerous general purpose or special purpose computing system environments or configurations. Examples of well known computing systems, environments, and/or configurations that may be suitable for use with the various technologies described herein include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The various technologies described herein may be implemented in the general context of computer-executable instructions, such as program modules, being executed by a computer. Generally, program modules include routines, programs, objects, components, data structures, etc. that performs particular tasks or implement particular abstract data types. The various technologies described herein may also be implemented in distributed computing environments where tasks are performed by remote processing devices that are linked through a communications network, e.g., by hardwired links, wireless links, or combinations thereof. In a distributed computing environment, program modules may be located in both local and remote computer storage media including memory storage devices.

FIG. 1 illustrates a schematic diagram of a computing system 100 in which the various technologies described herein may be incorporated and practiced. Although the computing system 100 may be a conventional desktop or a server computer, as described above, other computer system configurations may be used.

The computing system 100 may include a central processing unit (CPU) 21, a system memory 22 and a system bus 23 that couples various system components including the system memory 22 to the CPU 21. Although only one CPU is illustrated in FIG. 1, it should be understood that in some implementations the computing system 100 may include more than one CPU. The system bus 23 may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. The system memory 22 may include a read only memory (ROM) 24 and a random access memory (RAM) 25. A basic input/output system (BIOS) 26, containing the basic routines that help transfer information between elements within the computing system 100, such as during start-up, may be stored in the ROM 24.

The computing system 100 may further include a hard disk drive 27 for reading from and writing to a hard disk, a magnetic disk drive 28 for reading from and writing to a removable magnetic disk 29, and an optical disk drive 30 for reading from and writing to a removable optical disk 31, such as a CD ROM or other optical media. The hard disk drive 27, the magnetic disk drive 28, and the optical disk drive 30 may be connected to the system bus 23 by a hard disk drive interface 32, a magnetic disk drive interface 33, and an optical drive interface 34, respectively. The drives and their associated computer-readable media may provide nonvolatile storage of computer-readable instructions, data structures, program modules and other data for the computing system 100.

Although the computing system 100 is described herein as having a hard disk, a removable magnetic disk 29 and a removable optical disk 31, it should be appreciated by those skilled in the art that the computing system 100 may also include other types of computer-readable media that may be accessed by a computer. For example, such computer-readable media may include computer storage media and communication media. Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computing system 100. Communication media may embody computer readable instructions, data structures, program modules or other data in a modulated data signal, such as a carrier wave or other transport mechanism and may include any information delivery media. The term “modulated data signal” may mean a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media. Combinations of any of the above may also be included within the scope of computer readable media.

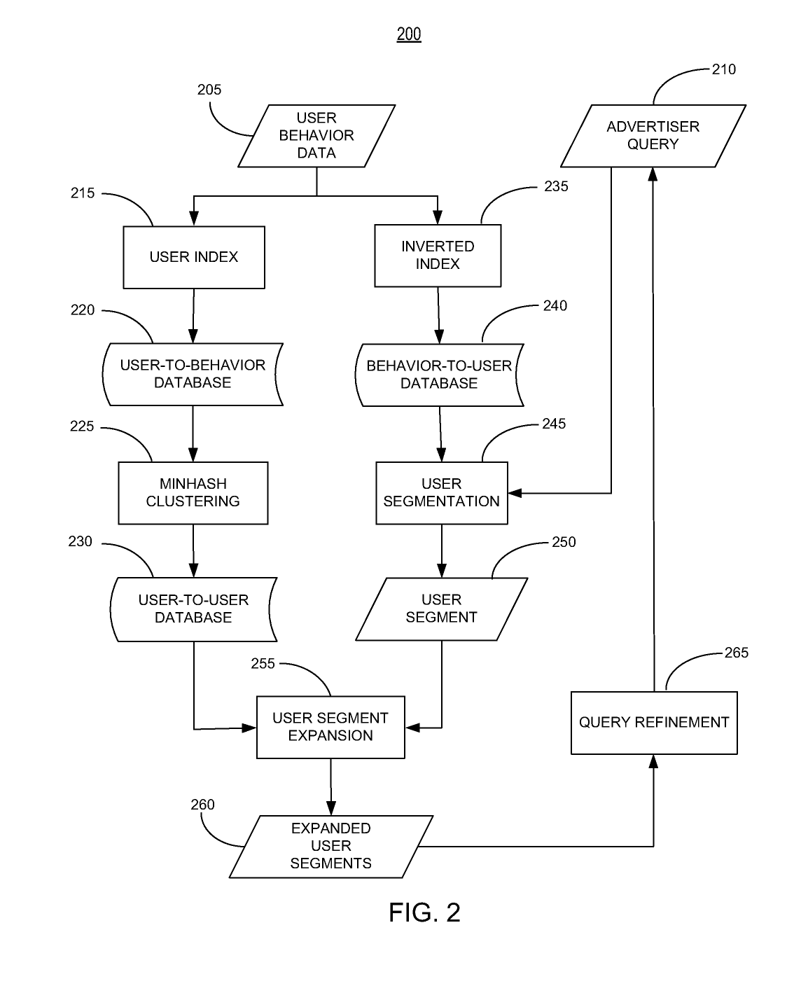

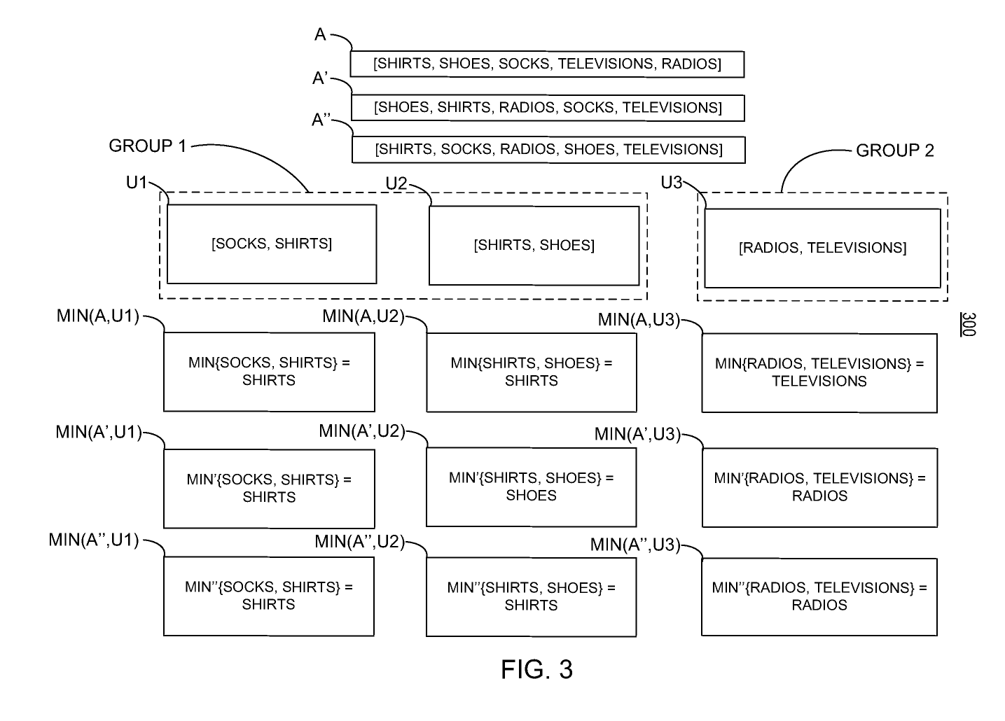

A number of program modules may be stored on the hard disk 27, magnetic disk 29, optical disk 31, ROM 24 or RAM 25, including an operating system 35, one or more application programs 36, a behavior data categorizer 60, program data 38, and a database system 55. The operating system 35 may be any suitable operating system that may control the operation of a networked personal or server computer, such as Windows® XP, Mac OS® X, Unix-variants (e.g., Linux® and BSD®), and the like. The behavior data categorizer 60 will be described in more detail with reference to FIGS. 2-3 in the paragraphs below.

A user may enter commands and information into the computing system 100 through input devices such as a keyboard 40 and pointing device 42. Other input devices may include a microphone, joystick, game pad, satellite dish, scanner, or the like. These and other input devices may be connected to the CPU 21 through a serial port interface 46 coupled to system bus 23, but may be connected by other interfaces, such as a parallel port, game port or a universal serial bus (USB). A monitor 47 or other type of display device may also be connected to system bus 23 via an interface, such as a video adapter 48. In addition to the monitor 47, the computing system 100 may further include other peripheral output devices such as speakers and printers.

Further, the computing system 100 may operate in a networked environment using logical connections to one or more remote computers 49. The logical connections may be any connection that is commonplace in offices, enterprise-wide computer networks, intranets, and the Internet, such as local area network (LAN) 51 and a wide area network (WAN) 52.

When using a LAN networking environment, the computing system 100 may be connected to the local network 51 through a network interface or adapter 53. When used in a WAN networking environment, the computing system 100 may include a modem 54, wireless router or other means for establishing communication over a wide area network 52, such as the Internet. The modem 54, which may be internal or external, may be connected to the system bus 23 via the serial port interface 46. In a networked environment, program modules depicted relative to the computing system 100, or portions thereof, may be stored in a remote memory storage device 50. It will be appreciated that the network connections shown are exemplary and other means of establishing a communications link between the computers may be used.

It should be understood that the various technologies described herein may be implemented in connection with hardware, software or a combination of both. Thus, various technologies, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the various technologies. In the case of program code execution on programmable computers, the computing device may include a processor, a storage medium readable by the processor (including volatile and non-volatile memory and/or storage elements), at least one input device, and at least one output device. One or more programs that may implement or utilize the various technologies described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

FIG. 2 illustrates a data flow diagram of a method for categorizing online user behavior data in accordance with one or more implementations of various techniques described herein. The following description of data flow diagram 200 is made with reference to computing system 100 of FIG. 1 in accordance with one or more implementations of various techniques described herein. It should be understood that while the operational data flow diagram 200 indicates a particular order of execution of the operations, in some implementations, certain portions of the operations might be executed in a different order. In one implementation, the method for categorizing online user behavior data may be performed by the behavior data categorizer 60.

Initially, the behavior data categorizer 60 may receive a user behavior data 205 and an advertiser query 210 as inputs to categorize online user behavior data. In one implementation, the user behavior data 205 may have been obtained using a search logging system. The search logging system may monitor the online behavior attributes of one or more users. The online behavior attributes may include a current web usage of each user, one or more web page addresses accessed by each user, the queries performed by each user, an amount or duration of time that a user spends on one or more web pages, a time stamp at which a web page was accessed by each user, one or more links selected by the users, a time stamp at which a query was requested by each user, a time stamp at which each link is selected by the users and the like. After monitoring the online behavior attributes of each user, the search logging system may create a log describing the online behavior attributes of each user. In one implementation, the log of the online behavior attributes of each user is the user behavior data 205. The user behavior data 205 may be presented as a table such that the first column of the table includes a list of user identifications (IDs), and the remaining columns include data pertaining to the online behavior attributes for each corresponding user ID.

The advertiser query 210 may include one or more online behavior attributes that may be of interest to an online advertiser. In one implementation, the online behavior attributes of the advertiser query 210 may be defined by an advertiser. The advertiser query 210 may provide advertisers with the ability to customize the manner in which the user behavior data may be categorized by the behavior data categorizer 60. Accordingly, the advertiser query 210 may be used to create a target group of users which may include those users who would be most interested in the advertisements of the advertiser. In one implementation, the advertiser query 210 may be defined by the advertiser via a user interface on the monitor 47.

The user behavior data 205 may be input into a user index module 215 and an inverted index module 235. The user index module 215 may organize the data in the user behavior data 205 into a formal format such that the data in the user behavior data 205 may be processed more efficiently. The output of the user index module 215 is the user-to-behavior database 220. In one implementation, upon receiving a user ID, the user-to-behavior database 220 may return the corresponding online behavior attributes of the received user ID. The user-to-behavior database 220 may also be referred to as a first category.

The user-to-behavior database 220 may then be input into a Minhash clustering module 225. In one implementation, the Minhash clustering module 225 may apply a Minhash algorithm to the user IDs and their corresponding online behavior attributes listed in the user-to-behavior database 220 to determine a Minhash signature for each user ID. The Minhash clustering module 225 may then organize the data in the user-to-behavior database 220 according to the Minhash signatures of each user such that the users having similar Minhash signatures may be grouped together. By grouping users having similar Minhash signatures together, the users may be grouped according to a higher degree of similarities as opposed to the user grouping defined in the user segmentation module 245. The user segmentation module 245 will be described in greater detail in the paragraphs below.

In one implementation, applying the Minhash algorithm to the data in the user-to-behavior database 220 may include defining a dataset (A) of all of the online behavior attributes as:

A={aⱼ|j=1, 2, 3 . . . }

where aⱼ represents an online behavior attribute.

Each user ID may defined in a dataset (U) such that:

U={uᵢ|i=1, 2, 3 . . . }

where uᵢ represents a user ID. Each user ID may then be denoted by its corresponding online behavior attributes such that:

uᵢ [symbol] A

Next, the Minhash algorithm may define a Minwise independent permutation as:

H={hₖ|k=1, 2, 3 . . . c} such that

Pr(min{hₖ(A)}=hₖ(aⱼ))=1/|A|

where hₖ represents a random permutation.

Next, the Minhash algorithm may define a Minwise hash function as:

mhₖ(uᵢ)=argmin{hₖ|uᵢ [symbol] A}

where mhₖ(uᵢ) returns the attribute with the smallest online behavior attribute aⱼ for user uᵢ, and mhₖ(uᵢ) represents the Minhash signature for user uᵢ.

The similarities between each pair of users in the user-to-behavior database 220 may then be determined according to their Minhash signatures:

sim(uᵢ,uⱼ)=|u₁∩u₂|/|u₁∪u₂|=Pr(mhₖ(uᵢ)=mhₖ(uⱼ))

where Pr(mhₖ(uᵢ)=mhₖ(uⱼ)) is approximated by |{mh_{g}(uᵢ)=mh_{g}(uⱼ), g=1, 2, . . . c}|/c.

After using the Minhash algorithm to determine the similarities between each pair of users in the user-to-behavior database 220, the Minhash clustering module 225 may store the similarities in a user-to-user database 230. The user-to-user database 230 may group each user ID with other user IDs having similar Minhash signatures. In one implementation, the number of groups in the user-to-user database 230 may depend on the number of users having similar Minhash signatures. Each user may be part of different groups so long as the users share a Minhash signature. The user-to-user database 230 may be presented as a table such that the column fields and row fields of the table include a list of the user IDs, and the content of the table indicates the Minhash signatures which are shared by pairs of user IDs. In one implementation, upon receiving a user ID, the user-to-user database 230 may return the corresponding user IDs having similar Minhash signatures of the received user ID. The user-to-user database 230 may be used to identify two or more user IDs having similar behavior attributes. An example of grouping users together based on their Minhash signatures is provided in the paragraphs below with respect to FIG. 3.

In one implementation, the Minhash clustering module 225 may use a parallel Minhash algorithm to determine the similarities between each pair of users in the user-to-behavior database 220 when the datasets representing the number of users (U) and their online behavior attributes (A) are large. The parallel Minhash algorithm may partition the large datasets into two or more partitioned datasets or categories such that the Minhash algorithm may be applied to each of the partitioned datasets in parallel computer systems. In this manner, the partitioned datasets may be distributed from the computing system 100 to one or more remote computers 49. Each remote computer 49 may then apply the Minhash algorithm to the partitioned dataset it received from the computer system 100 to determine the similarities between each pair of users in the partitioned dataset. Upon determining the similarities between each pair of users in each partitioned dataset, each remote computer 49 may send the similarities between each pair of users in each partitioned dataset to the computing system 100. The parallel Minhash algorithm may then aggregate or combine the received similarities. The Minhash clustering module 225 may then store the aggregated similarities in the user-to-user database 230.

In another implementation, the Minhash clustering module 225 may incrementally update the user-to-user database 230 using an incremental Minhash algorithm. Here, the incremental Minhash algorithm may include a time stamp (t) for each online behavior attribute such that:

Cuᵢ(t)={aᵢ₁, aᵢ₂, . . . }

where Cuᵢ(t) is a subset of A and i corresponds to the ID of uᵢ. Initially, at time t, the user-to-user database 230 may include a total of uₙ users and aₘ online behavior attributes. If a new user or new online behavior attribute in entered into the user behavior data 205 at a later time t+1, then the new user and the new online behavior attribute may be incrementally be assigned as uₙ₊₁ and aₘ₊₁, respectively. Accordingly, each Minhash signature of each user may be updated by:

mh_{[t,t+k]}(uᵢ)=min{mhₛ(uᵢ), s=t, t+1, t+2, . . . t+k}

In this manner, the Minhash algorithm may be incrementally be applied to each new user and each new online behavior as opposed to recalculating the Minhash signatures for all of the users and online behavior attributes in the user-to-behavior database 220. In one implementation, the users and online behavior attributes may be hashed daily and merged efficiently into the user-to-user database 230 using the incremental Minhash algorithm. As such, users may be grouped with respect to discrete time windows.

In yet another implementation, the incremental Minhash algorithm may be applied in a parallel computer environment using the parallel Minhash algorithm. Here, the combination of the incremental Minhash algorithm and the parallel Minhash algorithm may be referred to as a parallel incremental Minhash algorithm. The parallel incremental Minhash algorithm may partition large datasets representing the users and their online behavior attributes (Cuᵢ(t)) into two or more partitioned datasets such that the Minhash algorithm may be applied to each of the partitioned datasets in parallel computer systems. In this manner, the partitioned datasets may be distributed from the computing system 100 to one or more remote computers 49. Each remote computer 49 may then apply the incremental Minhash algorithm to the partitioned dataset it received from the computer system 100 to determine the Minhash signatures between each pair of users in the partitioned dataset for each time t. Upon determining the Minhash signatures between each pair of users in each partitioned dataset for each time t, each remote computer 49 may send the Minhash signatures between each pair of users in each partitioned dataset Minhash signatures to the computing system 100. The parallel incremental Minhash algorithm may then determine the similarities between each pair of users for each time t. The Minhash clustering module 225 may then aggregate the received similarities and store the aggregated similarities in the user-to-user database 230. Although the Minhash clustering module 225 has been described using a Minhash algorithm to identify the similarities between users in the user-to-behavior database 220, it should be noted that in some implementations, other algorithms may be used to identify similarities between users instead of the Minhash algorithm. For example, a pair-wise similarity function (e.g., cosine similarity, Jaccard coefficients) or a clustering algorithm (e.g., K-means) may be used to identify similarities between the users in the user-to-behavior database 220.

Referring back to the user behavior data 205, the user behavior data 205 may also be input into the inverted index module 235. The inverted index module 235 may invert the data in the user behavior data 205 such that each online behavior attribute may be listed on an individual row of a table and the remaining columns of the table may indicate the user IDs that may have the corresponding online behavior attribute. As such, the output of the inverted index module 235 may be the behavior-to-user database 240. In one implementation, upon receiving an online behavior attribute, the behavior-to-user database 240 may return the corresponding user IDs having the received online behavior attribute. The behavior-to-user database 220 may also be referred to as a second category.

The behavior-to-user database 240 and the advertiser query 210 may then be input into a user segmentation module 245. The user segmentation module 245 may segment or group the user IDs in the behavior-to-user database 240 based on the online behavior attributes defined in the advertiser query 210. The output of the user segmentation module 245 may be the user segment 250 which may also be referred to as a target set of users. In this manner, the advertiser may customize the user segment 250 such that the users in the user segment 250 may be those users who are interested in advertisements related to the advertiser. For example, if the advertiser query 210 specifies online behavior attributes related to “running shoes,” the user segmentation module 250 may input “running shoes” into the behavior-to-user database 240, and the behavior-to-user database 240 may return the users who had online behavior attributes related to running shoes as the user segment 250. In this manner, the user segment 250 may be a list of user IDs having the online behavior attribute defined in the advertiser query 210. The user segment 250 may be presented as a table such that the first column of the table is the list of user IDs, and the remaining columns describe the online behavior attributes of the corresponding user ID. Although the behavior-to-user database 240 has been described as being input into the user segmentation module 245, it should be noted that in some implementations a subset of the behavior-to-user database 240 (e.g, a subset that is less than the whole database 240) may be input into the user segmentation module 245 to decrease computing costs. The subset of the behavior-to-user database 240 may include part of the behavior-to-user database 240 that has information pertaining to the users having online behavior attributes that are most relevant to the advertiser query 210 or the like.

The user segment 250 and the user-to-user database 230 may then be input into a user segment expansion module 255. The user segment expansion module 255 may then expand the user segment 250 into groups of user IDs based on each user ID's Minhash signature as defined in the user-to-user database 230. An example of how the user expansion module 255 may group the user IDs in the user segment 250 is provided below in FIG. 3. The output of the user segment expansion module 255 is the expanded user segments 260. The expanded user segments 260 may group the users in the user segment 250 into smaller groups to identify the users within the user segment 250 having a higher degree of similarities with each other. For example, the user segment 250 may indicate that the users in the user segment 250 may all have a common interest in running shoes. The expanded user segments 260 may then identify and group the users who may be interested in a particular brand of running shoes together. This higher degree of similarities illustrated in the expanded user segments 260 may be useful for advertisers to identify more specific user groups who may be most interested in their products.

The expanded user segments 260 may then be displayed on the monitor 47. In one implementation, the expanded user segments 260 may be displayed such that the advertiser may view the user IDs and their corresponding online behavior attributes. If the advertiser is not satisfied with the data provided in the expanded user segments 260, the advertiser may refine the expanded user segments 260 in the query refinement module 265. In one implementation, the advertiser may not be satisfied with the expanded user segments 260 because the expanded user segments 260 may indicate users having similarities that may not be related to the advertiser's products or services. The query refinement module 265 may allow the advertiser to modify one or more online behavior attributes listed in the advertiser query 210, or it may allow the advertiser to completely change the advertiser query 210 such that the expanded user segments 260 may better fit the advertiser's needs. Upon altering the advertiser query 210, the process defined in FIG. 2 may be repeated using the altered advertiser query until the advertiser is satisfied with the expanded user segments 260.

FIG. 3 illustrates an example of a method for expanding a user segment in accordance with one or more implementations of various techniques described herein. The following description of the example 300 is made with reference to the Minhash clustering module 225 and the user segment expansion module 255 as described in FIG. 2 in accordance with one or more implementations of various techniques described herein. The example 300 is presented herein only to serve as an example, and it is not meant to limit the scope of the method for categorizing online user behavior data.

In FIG. 3, three random Minwise permutations of online behavior attributes have been generated (A, A′, A″). Only three random Minwise permutations have been provided in this example so that the method for expanding the user segment can be readily understood. However, it should be noted that in other implementations any number of random Minwise permutations may be used. In one implementation, the online behavior attributes may include accessing web pages designed for selling shirts, shoes, socks, televisions and radios. Each random Minwise permutation of the online behavior attributes may list one or more online behavior attributes in a random order. For example, in random Minwise permutation A, the first online behavior attribute is shirts the second online behavior attribute is shoes, the third online behavior attribute is socks, the fourth online behavior attribute is televisions and the fifth online behavior attribute is radios. In this example, the first online behavior attribute is considered to be the lowest ranking online behavior attribute and the fifth online behavior attribute is considered to be the highest ranking online behavior attribute.

The users listed in FIG. 3 (U1, U2, U3) may reflect the users listed in the user segment 250 described in FIG. 2. Each user has its corresponding online behavior attributes listed in the user segment 250. However; it should be noted that the order in which the online behavior attributes are listed for each user in FIG. 3 does not indicate a particular order or ranking for the purposes of this example. Instead, the online behavior characteristics listed for each user are simply used to indicate that the user has or possesses these online behavior characteristics, and not whether one of the user's attributes is more important to the user than another of the user's attributes. As such, user U1 has online behavior attributes consisting of socks and shirts, user U2 has online behavior attributes consisting of shirts and shoes, and user U3 has online behavior attributes consisting of radios and televisions.

The Minhash signatures for each user (U1, U2, U3) with respect to each random Minwise permutation (A, A′, A″) are illustrated below each corresponding user. In one implementation, the Minhash signatures may be located in the user-to-user database 230 as described in FIG. 2. Using the Minhash signatures provided in the user-to-user database 230 and the user list provided in the user segment 250, the user segment expansion module 255 may group the users listed in the user segment 250 according to their similar Minhash signatures.

Referring back to the example provided in FIG. 3, the Minhash signature for each user and Minwise permutation pair is determined by identifying the lowest ranking online behavior attribute for each user based on the ranking of the user's corresponding Minwise permutation. For example, user U1's online behavior attributes include “socks” and “shirts.” For the user U1 and Minwise permutation A pair, the rank of the online behavior attributes is defined by the order in which the Minwise permutation A lists its online behavior attributes. As such, with respect to the online behavior attributes of user U1, the Minwise permutation A indicates that “shirts” is ranked lower than “socks.” Therefore, user U1's Minhash signature (e.g., min(A,U1)) for Minwise permutation A is “shirts.” Similarly, user U1's Minhash signatures (e.g., min(A′,U1), min(A″,U1)) for Minwise permutations A′ and A″ are “shirts” and “shirts,” respectively. User U2's Minhash signatures (e.g.; min(A,U2), min(A′,U2), min(A″,U2)) for Minwise permutations A, A′, and A″ are “shirts,” “shoes,” and “shirts,” respectively. User U3's Minhash signatures (e.g., min(A,U3), min(A′,U3), min(A″,U3)) for Minwise permutations A, A′, and A″ are “televisions,” “radios,” and “radios,” respectively. By examining all of the Minhash signatures for each user and each Minwise permutation, it is apparent that both user U1 and user U2 share similar Minhash signatures “shirts.” In contrast, user U3 does not share any Minhash signatures with either user U1 or user U2. In this manner, the user segment expansion module 255 may group user U1 and user U2 together to form group 1. User U3 may be designated as group 2 because it has distinct online behavior attributes as compared to user U1 and user U2. In one implementation, group 1 and group 2 may represent the expanded user segments 260 as described in FIG. 2. As such, an advertiser who sells clothing items may target their advertisements to the users in group 1 because these users are more likely interested in clothing items such as socks, shirts and shoes as opposed to the user in group 2 who is more interested in electronic items. The advertiser may use the expanded user segments 260 to direct their advertisements to users in order to more efficiently use their advertisements.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for categorizing online user behavior data, comprising:
creating a target set of users based on an advertiser query;
identifying two or more users in the target set having one or more first similar behavior attributes using a Minhash algorithm; and
modifying the target set according to the two or more identified users.

2. The method of claim 1, wherein creating the target set comprises:
receiving user behavior data from a search logging system, the user behavior data having information pertaining to one or more users and one or more behavior attributes corresponding to the users;
categorizing the user behavior data into a second category according to the behavior attributes; and
determining the target set based on the second category and the advertiser query.

3. The method of claim 2, wherein the behavior attributes comprise one or more queries performed by the users, one or more web page addresses accessed by the users, one or more amounts of time that the users spend on one or more web pages, one or more links selected by the users, one or more time stamps at which the web pages are accessed by the users, one or more time stamps at which the links are selected by the users, or combinations thereof.

4. The method of claim 1, wherein the two or more users are identified using parallel computer systems.

5. The method of claim 2, wherein identifying the two or more users comprises:
categorizing the user behavior data into a first category according to the users;
partitioning the first category into two or more partitioned categories;
sending the partitioned categories to one or more computer systems, wherein each computer system is configured to identify two or more users having one or more second similar behavior attributes in one of the partitioned categories using the Minhash algorithm;
receiving the two or more users having the second similar behavior attributes in the one of the partitioned categories; and
combining the two or more users having the second similar behavior attributes in the one of the partitioned categories.

6. The method of claim 5, wherein the Minhash algorithm is an incremental Minhash algorithm.

7. The method of claim 2, wherein identifying the two or more users comprises:
categorizing the user behavior data into a first category according to the users;
defining one or more Minwise independent permutations of the first category;
defining one or more Minwise hash functions based on the Minwise independent permutations;
determining one or more Minhash signatures using the Minwise hash functions; and
determining one or more similarities between two or more of the users based on the Minhash signatures.

8. The method of claim 7, wherein modifying the target set comprises grouping the two or more identified users based on the similarities.

9. The method of claim 2, further comprising revising the advertiser query based on the modified target set.

10. The method of claim 9, further comprising creating an updated target set based on the second category and the revised advertiser query.

11. The method of claim 1, wherein the advertiser query comprises one or more behavior attributes defined by an advertiser.

12. The method of claim 1, wherein the Minhash algorithm is a parallel Minhash algorithm, an incremental Minhash algorithm, or a parallel incremental Minhash algorithm.

13. A computer-readable storage medium having stored thereon computer-executable instructions which, when executed by at least one computer, cause the at least one computer to:
receive user behavior data from a search logging system, the user behavior data having information pertaining to one or more users and one or more behavior attributes corresponding to the users;
categorize the user behavior data into a first category according to the users;
categorize the user behavior data into a second category according to the behavior attributes;
create a target set of users based on the second category and an advertiser query;
identify two or more users in the target set having one or more similar behavior attributes based on the first category; and
modify the target set based on the two or more identified users.

14. The computer-readable storage medium of claim 13, wherein the two or more users are identified using an incremental Minhash algorithm that incrementally applies a Minhash algorithm based on one or more time stamps corresponding to the user behavior data.

15. The computer-readable storage medium of claim 13, wherein the computer-executable instructions which, when executed by the computer, cause the computer to identify the two or more users comprises computer-executable instructions which, when executed by a computer, cause the computer to:
define one or more Minwise independent permutations of the first category;
define one or more Minwise hash functions based on the Minwise independent permutations;
determine one or more Minhash signatures using the Minwise hash functions; and
determine one or more similarities between two or more of the users based on the Minhash signatures.

16. The computer-readable storage medium of claim 13, wherein the two or more users are identified using multiple computers.

17. A computer system, comprising:
at least one processor; and
a memory comprising program instructions that when executed by the at least one processor, cause the at least one processor to:
receive user behavior data from a search logging system, the user behavior data having information pertaining to one or more users and one or more behavior attributes corresponding to the users;
categorize the user behavior data into a first category according to the users;
categorize the user behavior data into a second category according to the behavior attributes;
create a target set of users based on the second category and an advertiser query;
identify two or more users having one or more similar behavior attributes based on the first category;
modify the target set based on the two or more identified users;
revise the advertiser query based on the modified target set; and
create an updated target set based on the second category and the revised advertiser query.

18. The computer system of claim 17, wherein the behavior attributes comprise one or more queries performed by the users, one or more web page addresses accessed by the users, one or more amounts of time that the users spend on one or more web pages, one or more links selected by the users, one or more time stamps at which the web pages are accessed by the users, one or more time stamps at which the links are selected by the users, or combinations thereof.

19. The computer system of claim 17, wherein the two or more users are identified using a parallel incremental Minhash algorithm.

20. The computer system of claim 17, wherein the advertiser query comprises one or more behavior attributes defined by an advertiser.
